(19) United States
(12) Patent Application Publication
(10) Pub. No.: US 2026/0167312 A1
(43) Pub. Date: Jun. 18, 2026

(54) METHOD, AUTONOMOUS UNDERWATER VEHICLE, BASE STATION

(71) Applicant: BP Exploration Operating Company Limited, Middlesex (GB)

(72) Inventor: Ben HOLLINGS, Claremont (AU)

(73) Assignee: BP Exploration Operating Company Limited, Middlesex (GB)

(21) Appl. No.: 19/421,276

(22) Filed: Dec. 16, 2025

(30) Foreign Application Priority Data
Dec. 17, 2024 (GB) 2418479.8

(51) Int. Cl. B63G 8/00; G01V 1/38

(52) U.S. Cl. CPC B63G 8/001; G01V 1/3835; G01V 1/3852; B63G 2008/004; B63G 2008/008

(57) ABSTRACT

A method performed by an autonomous underwater vehicle. The method comprising: the autonomous underwater vehicle landing at a position on the seabed; collecting, via one or more sensors of the autonomous underwater vehicle, data relating to the position of the autonomous underwater vehicle; determining using the collected data, whether one or more landing quality criteria have been met, the landing criteria being indicative of a satisfactory position on the seabed; and when it is determined that one or more of the landing quality criteria has not been met, the controller causes the autonomous underwater vehicle to perform an action.

### CROSS-REFERENCE TO RELATED APPLICATIONS

This application claims benefit of and priority to GB2418479.8 filed 17 Dec. 2024, and entitled “Method, Autonomous Underwater Vehicle, Base Station,” the contents and elements of which are hereby incorporated herein by reference for all purposes.

### TECHNICAL FIELD

The present disclosure relates to a method, an autonomous underwater vehicle, and a base station.

### BACKGROUND

There is an increasing desire to use autonomous underwater vehicles (AUVs), of the type discussed in GB2541189, to perform large scale underwater data collection. For example, to record seismic signals during a marine seismic survey.

AUVs typically include passive buoyancy systems, whereby a bladder holds a gas which is compressed by hydrostatic pressure as the AUV descends under the power of a thruster. AUVs can also have active buoyancy systems, for example where water is pumped in and out of a ballast tank to vary the buoyancy of the AUV.

The landing condition of the AUV is important for the quality of collected data, especially in seabed sampling applications. However, when the AUV is autonomously sent to the target, the landing site may not be observed prior to landing/placement. There may also be no feedback from the operator prior to landing.

The present disclosure was arrived at in light of the above considerations.

### SUMMARY

Accordingly, in a first aspect, embodiments of the invention provide a method performed by an autonomous underwater vehicle, the method comprising:
the autonomous underwater vehicle landing at a position on the seabed;
collecting, via one or more sensors of the autonomous underwater vehicle, data relating to the position of the autonomous underwater vehicle;
determining, using the collected data, whether one or more landing quality criteria have been met, the landing criteria being indicative of a satisfactory position on the seabed; and
when it is determined that one or more of the landing criteria has not been met, the autonomous underwater vehicle performing an action.

Such a method allows the autonomous underwater vehicle to automatically determine whether the previously performed landing is satisfactory enough to allow for data collection.

The collected data may be vibrational data, and the landing quality criteria may be established by comparing an average of the vibrational data to a threshold level. The average may be an RMS average. The vibrational data may be noise data collected by one or more seismic sensors of the autonomous underwater vehicle (e.g. pressure/vibrational readings). The threshold may be based on historic data of known good landings performed by previous autonomous underwater vehicles. The vibrational data may be collected over a time period, e.g., over a 10 second, 1 minute, 5 minute, or 10 minute time period. The threshold may be derived by the autonomous underwater vehicle. For example, the autonomous underwater vehicle may collect vibrational data whilst on the deck of a deployment surface vessel, during an entry into the water from a surface vessel, during transit to a survey site, and after landing at the survey site. The threshold may be derived from the data collected during these phases (for example, by being set below or at the level measured during transit, or during entry into the water).

Herein, the term autonomous underwater vehicle is intended to be synonymous with and equivalent to the term uncrewed underwater vehicle. The autonomous underwater vehicle includes at least some degree of autonomous functionality, which may include significant levels of autonomous functionality. However it may also be remotely controlled, either directly or indirectly, by an operator (for example located in a surface vessel).

A controller of the autonomous underwater vehicle may determine whether the one or more landing quality criteria have been met. This can minimise the transmission of data from the autonomous underwater vehicle, which is advantageous when a large number of such vehicles are deployed.

A remote controller, remote from the autonomous underwater vehicle, may determine whether the one or more landing quality criteria have been met, the method including the autonomous underwater vehicle transmitting at least some of the collected data to the remote controller. The remote controller may be located in a base station of the type discussed below. This can allow more computationally intense analysis to be performed, of the type which may be unsuitable for the autonomous underwater vehicle to perform due to power and/or computing power constraints.

The action may be one or more of:
adjusting a bottom pressure of the autonomous underwater vehicle;
initiating a take-off of the autonomous underwater vehicle from the seabed;
initiating a take-off and re-landing sequence of the autonomous underwater vehicle; and
communicating with a base station, indicating to the base station that one or more of the landing quality criteria has not been met, and subsequently performing a further action on receipt of a message from the base station.

The collected data may include or may be used to derive a quality indicator of seismic data collected by the sensor, and the landing quality criteria may be a threshold of acceptable seismic data quality. The quality indicator of seismic data collected by the sensor may be derived by a controller of the autonomous underwater vehicle or by a remote controller, remote from the autonomous underwater vehicle.

The collected data may include navigational data. The navigational data may be compared to target navigational data, and the one or more landing quality criteria may include one or more thresholds indicative of a maximum acceptable deviation between the navigational data and the target navigational data. The navigational data may include attitude of the autonomous underwater vehicle, orientation of the autonomous underwater vehicle, depth of the autonomous underwater vehicle, position of the autonomous underwater vehicle, and/or position of the autonomous underwater vehicle as compared to a predetermined target position.

The autonomous underwater vehicle may be configured to wait for at least a predetermined period after landing and before collecting the data. The predetermined period may be 1 second, 30 seconds, 1 minute, 10 minutes, 30 minutes, or 1 hour.

In a second aspect, embodiments of the invention provide an autonomous underwater vehicle including a processor or controller configured to perform the method of the first aspect, including any one or any combination of the optional features set out with reference thereto. The autonomous underwater vehicle may await an authorisation signal from a base station before performing a further action.

In a third aspect, embodiments of the present invention provide a base station for use with the autonomous underwater vehicle of the second aspect, the base station being configured to receive a signal from the autonomous underwater vehicle, including receiving either the collected data or determination of landing quality criteria, and either determining authorisation automatically or receiving authorisation at a terminal, and then communicating the authorisation to the autonomous underwater vehicle. The authorisation may constitute a message as discussed previously, indicating that the autonomous underwater vehicle is permitted to reposition itself on the seabed (i.e., take off and re-land).

The invention includes the combination of the aspects and preferred features described except where such a combination is clearly impermissible or expressly avoided.

Further aspects of the present invention provide: a computer program comprising code which, when run on a computer, causes the computer to perform the method of the first aspect; a computer readable medium storing a computer program comprising code which, when run on a computer, causes the computer to perform the method of the first aspect; and a computer system programmed to perform the method of the first aspect.

### BRIEF DESCRIPTION OF THE DRAWINGS

FIG. 1 shows an autonomous underwater vehicle in communication with a base station;

FIG. 2 shows a partial enlarged view of the autonomous underwater vehicle; and

FIG. 3 shows a method.

### DETAILED DESCRIPTION

Aspects and embodiments of the present invention will now be discussed with reference to the accompanying figures. Further aspects and embodiments will be apparent to those skilled in the art.

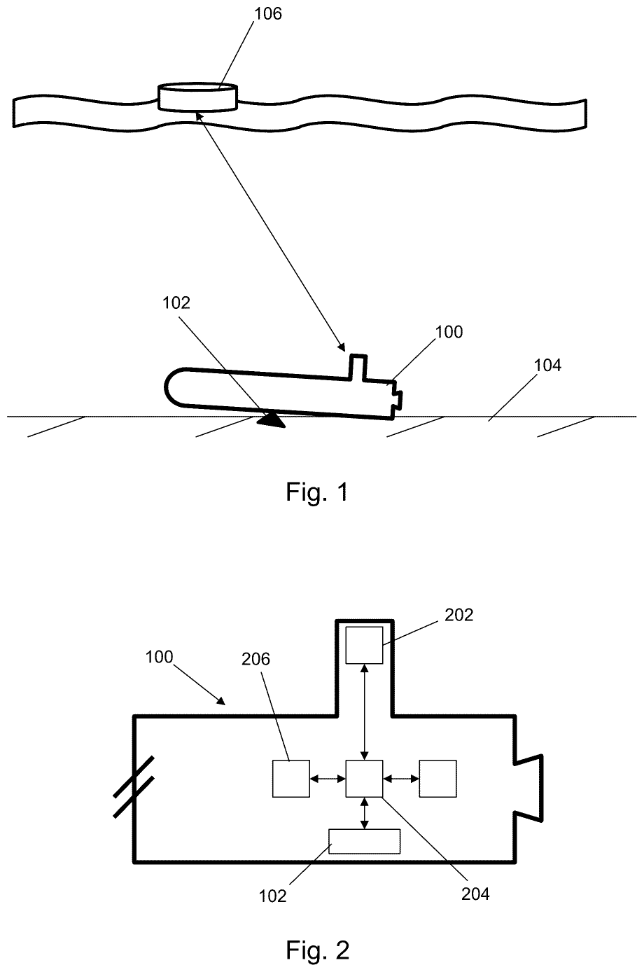

FIG. 1 shows an autonomous underwater vehicle 100, in this example in communication with a base station 106. The autonomous underwater vehicle has landed on the seabed 104, but a seismic sensor 102 located on the bottom of the vehicle is not level with the seabed 104. This may be reflected in the quality of collected seismic data. If the quality is sufficiently poor, the AUV may perform some mitigation action as described herein.

FIG. 2 shows a partial enlarged view of the autonomous underwater vehicle 100. The AUV includes processor or controller 204 connected to a seismic sensor 102 and also a communication module 202 (e.g., acoustic transceiver) which allows the AUV to communicate with the base station 106 (in this example a floating platform, surface vessel or other mobile support craft).

In some examples, different, or additional data, is collected (such as attitude, orientation etc.) via further sensors 206. This can be used alone, or in combination with the collected seismic data. In some examples, where multiple data types are to be collected, if the seismic data is of sufficient quality (e.g., the root mean square deviation is low enough), then the lack of compliance of the other data types (position, orientation, etc.) may be ignored and the AUV can remain at its current location.

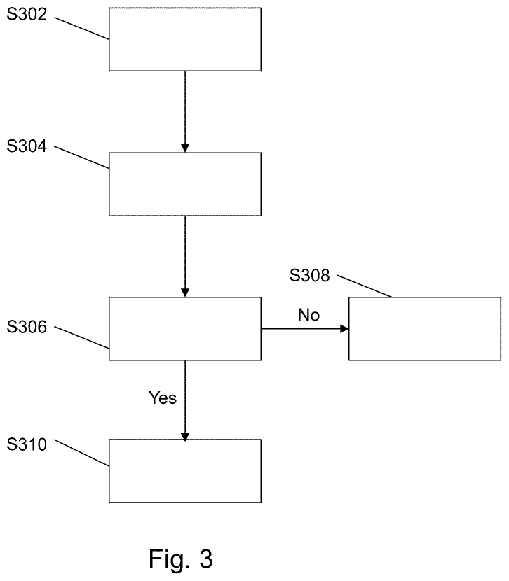

FIG. 3 shows a method. In a first step, S302, the autonomous underwater vehicle 100 lands at a position on the seabed. Next, in step S304, the autonomous vehicle uses one or more sensors 102, 206, to collect data relating to the position of the autonomous underwater vehicle. This allows, in step S306, a determination to be made, on the basis of the collected data, as to whether the autonomous underwater vehicle has landed in a satisfactory position on the seabed. If the determination is that it has, ‘Yes’, the method moves to step 310 and further data collection can be performed (for example, a seismic survey). However, if the determination is that it has not, ‘No’, the method moves to step S308 and an action is performed to attempt to mitigate this.

As has been discussed previously, in some examples the sensor(s) of the autonomous underwater vehicle 100 collect vibrational data (e.g., noise data). In step S306, the root mean square deviation of the collected data is compared to a threshold value (arrived at empirically, based on vibrational profiles acquired from autonomous underwater vehicles known to have landed in a satisfactory manner). If the RMS is less than the threshold value, then a satisfactory landing is determined. If it is greater than the threshold value, then an unsatisfactory landing is determined (and mitigation occurs).

In this example, the autonomous underwater vehicle 100 determines, itself, if the landing is unsatisfactory, and then as a first mitigation action adjusts the bottom pressure it is exerting on the seabed in an attempt to improve the contact therebetween. This can be done by decreasing the positive buoyancy, e.g., by pumping water into ballast tanks or by decreasing the volume of gas bladders. The autonomous underwater vehicle 100 then, after a period of time (e.g., 10 seconds, 1 minute, etc.) collects fresh vibrational data and redetermines if the landing is satisfactory in the same manner as discussed previously. If it is now satisfactory, the autonomous underwater vehicle can transition into a data collection mode (e.g., performing a seismic survey). If it is not, a further mitigation action may be undertaken such as initiating a take-off and re-landing sequence. If, after a number of (e.g., at least two) mitigation actions have been attempted without a satisfactory landing being determined, the autonomous underwater vehicle may report as much to the base station. The base station can then authorise further actions, such as a relocation of the target location for landing, or similar.

The systems and methods of the above embodiments may be implemented in a computer system (in particular in computer hardware or in computer software) in addition to the structural components and user interactions described.

The term “computer system” includes the hardware, software and data storage devices for embodying a system or carrying out a method according to the above described embodiments. For example, a computer system may comprise a central processing unit (CPU), input means, output means and data storage. The computer system may have a monitor to provide a visual output display. The data storage may comprise RAM, disk drives or other computer readable media. The computer system may include a plurality of computing devices connected by a network and able to communicate with each other over that network.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

While the disclosure has been described in conjunction with the exemplary embodiments described above, many equivalent modifications and variations will be apparent to those skilled in the art when given this disclosure. Accordingly, the exemplary embodiments of the disclosure set forth above are considered to be illustrative and not limiting. Various changes to the described embodiments may be made without departing from the spirit and scope of the disclosure.

In particular, although the methods of the above embodiments have been described as being implemented on the systems of the embodiments described, the methods and systems of the present disclosure need not be implemented in conjunction with each other, but can be implemented on alternative systems or using alternative methods respectively.

The features disclosed in the description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the disclosure in diverse forms thereof.

While the disclosure has been described in conjunction with the exemplary embodiments described above, many equivalent modifications and variations will be apparent to those skilled in the art when given this disclosure. Accordingly, the exemplary embodiments of the disclosure set forth above are considered to be illustrative and not limiting. Various changes to the described embodiments may be made without departing from the spirit and scope of the disclosure.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

What is claimed is:

1. A method performed by an autonomous underwater vehicle, the method comprising:
landing at a position on the seabed;
collecting, via one or more sensors of the autonomous underwater vehicle, data relating to the position of the autonomous underwater vehicle;
determining using the collected data, whether one or more landing quality criteria have been met, the landing criteria being indicative of a satisfactory position on the seabed; and
when it is determined that one or more of the landing criteria has not been met, the autonomous underwater vehicle performing an action.

2. The method of claim 1, further comprising, after the action is performed, repeating the collecting and determining steps and performing a further action upon a further determined that the one or more of the landing criteria has not been met.

3. The method of claim 1, wherein the collected data is vibrational data, and the landing quality criteria is established by comparing an average of the vibrational data to a threshold level.

4. The method of claim 1, wherein a controller of the autonomous underwater vehicle determines whether the one or more landing quality criteria have been met.

5. The method of claim 1, wherein a remote controller, remote from the autonomous underwater vehicle, determines whether the one or more landing quality criteria have been met, the method including the autonomous underwater vehicle transmitting at least some of the collected data to the remote controller, for example a remote controller in a base station.

6. The method of claim 1, wherein the action is one or more of:
adjusting a bottom pressure of the autonomous underwater vehicle;
initiating a take-off of the autonomous underwater vehicle from the seabed;
initiating a take-off and re-landing sequence of the autonomous underwater vehicle; and
communicating with a base station, indicating to the base station that one or more of the landing quality criteria has not been met, and subsequently performing a further action on receipt of a message from the base station.

7. The method of claim 1, wherein the collected data includes or is used to derive, a quality indicator of seismic data collected by a sensor, and the landing quality criteria is a threshold of acceptable seismic data quality.

8. The method of claim 7, wherein the quality indicator of seismic data collected by the sensor is derived by a controller of the autonomous underwater vehicle or by a remote controller, remote from the autonomous underwater vehicle.

9. The method of claim 1, wherein the collected data includes navigational data.

10. The method of claim 9, wherein the navigational data is compared to target navigational data, and the one or more landing quality criteria includes one or more thresholds indicative of the maximum acceptable deviation between the navigational data and the target navigational data.

11. The method of claim 9, wherein the navigational data includes attitude of the autonomous underwater vehicle, orientation of the autonomous underwater vehicle, depth of the autonomous underwater vehicle, position of the autonomous underwater vehicle, and/or position of the autonomous underwater vehicle as compared to a predetermined target position.

12. The method of claim 1, wherein the autonomous underwater vehicle is configured to wait for at least a predetermined period after landing and before collecting the data, for example 1 second, 30 seconds, 1 minute, 10 minutes, 30 minutes, or 1 hour.

13. An autonomous underwater vehicle including a processor or controller configured to perform the method of claim 1.

14. A base station for use with the autonomous underwater vehicle of claim 13, the base station being configured to receive a signal from the autonomous underwater vehicle, including receiving either the collected data or determination of landing quality criteria, and either determining authorisation automatically or receiving authorisation at a terminal, and then communicating the authorisation to the autonomous underwater vehicle.
